(19) United States
(12) Patent Application Publication
(10) Pub. No.: US 2023/0174297 A1
(43) Pub. Date: Jun. 8, 2023

(54) Single-Ring Hand Mounted Secure Item Waste Receptacle

(71) Applicant: Philip Krieg, Phoenixville, PA (US)

(72) Inventor: Philip Krieg, Phoenixville, PA (US)

(21) Appl. No.: 18/103,232

(22) Filed: Jan. 30, 2023

Related U.S. Application Data
(63) Continuation-in-part of application No. 17/090,875, filed on Nov. 5, 2020.

(51) Int. Cl. B65F 1/14

(52) U.S. Cl. CPC B65F 1/141; B65F 2230/00

(57) ABSTRACT

A hand mounted secure waste item receptacle is described having a hollow container with a base formed to a single ring-shaped structure sized appropriately for mounting to one or more fingers of a human hand and stabilized against rotational motion. The top surface of the container has a central opening with narrowing slots extending radially outward providing access for the waste items and tool holding such items to be positioned therein and moved outward within any of the slots allowing for a wiping action to remove the waste item from the tool with the waste item to remain within the hollow receptacle.

### TECHNICAL FIELD

This application relates, in general, to an article of manufacture for providing a single ring-shaped hand mounted secure item waste receptacle useful for the temporary storage of waste items until final disposal.

### BACKGROUND OF THE INVENTION

Office workers and other individuals interact with and create material which involves printed items that are consumed by others. Additionally, many hobby crafters often find themselves picking up small scraps of sticky vinyl with a small crafting hook similar to a dental pick. These printed items are typically a mix of graphics and text and may also include other physical objects. These small sticky pieces of waste vinyl are often troublesome, as there is no quick convenient way to remove them from the end of the crafting hook. Typically, crafters will have to remove the sticky vinyl with their fingers, leaving waste vinyl all over the crafting area, something that is rather bothersome to clean up. Sometimes crafters will have a small trash can on their desk, but this is inconvenient because it takes up a lot of valuable desk space, slides around, and is annoying to reach over and use.

While the workers are creating their documents, their desktops may become cluttered with items that are removed from the work in progress or excess material that may be added to the physical renderings of these documents while the documents are being created. This clutter can get in the way of a worker efficiently creating these documents, especially when the documents are complex and require creativity to visualize their creation.

A device that may seem similar, but is different in structure and purpose, is the one described in U.S. Pat. No. 9,585,455 [Boyle, et al.] This device is described as a holder for a nail polish bottle that is capable of being mounted to at least two fingers of a user's hand. The crown 106 has an equal number of opposing slits 108 that push inward into a cavity within the holder 101 to secure and retain a nail polish bottle within the cavity such that the bottle moves with the user's hand and does not tip or fall. The holder 101 is attached to a user's hand by first and second ring portions 102, 103, not a single ring as in the present invention. The only reference to a single ring in the disclosure is to ring 403 that is configured to fit about a user's wrist and not more than a single finger. There is no mention, suggestion, description or disclosure of using the device as a waste container, using the slits to wipe waste items into the cavity for temporary storage, or that the container can be stabilized with fewer than two fingers. The squeeze tabs 105 are not used to stabilize the device but are utilized to open the slits 104 at the bottom of the ring-shaped openings for accommodating larger fingers or the placement of the device onto a user's fingers. All in all, this device is described as having a vastly different purpose, has some similar structures but uses them for dissimilar operations, and fails to limit its structure to a single ring rendering this patent disclosure merely of note and with limited interest to the present invention. A companion patent by the same inventor, U.S. Design Pat. D821,033 [Boyle, et al.], clearly shows the same elements as being useful for a nail polish bottle holder and not a waste receptacle.

My prior invention attempted to address the existing limitations in the art by providing a secure desktop item receptacle, i.e., a type of receptacle that securely attaches to the desktop with a suction cup and provides a usefully shaped opening for providing workers with a means to reduce desk/work area clutter and provide the worker with a place to store the waste while the documents are being created. The present invention also attempts to address those existing limitations of desk/work area clutter by providing a secure hand mounted waste item receptacle while reducing desk/work area clutter and providing the worker with a secure place to store the waste items as the documents are being created. The off-desk hand mounted waste storage process is especially useful for graphic artists who work with physical renditions of items requiring layers of textured materials, rather than digital representations of the same objects.

It is, therefore, an object of the present invention to create a secure item waste receptacle that can be mounted to one or more fingers of a human hand. It is a further object to create a single ring-shaped mount that is adjustable for one or more fingers on the hand of the user. It is also an object of the present invention to provide additional stabilizing arms to the hand mount if the single ring-shaped mount is sized for a single finger. Other objects will appear hereinafter.

### SUMMARY OF THE INVENTION

In accordance with the present invention, the above and other problems are solved, and the stated objects obtained, by providing an article of manufacture for a hand mounted secure waste item receptacle.

In one aspect of the present disclosure, the hand mounted secure waste item receptacle is comprised of a hollow container having a base formed to a single ring-shaped structure sized appropriately for mounting to one or more fingers of a human hand, The top surface of the container has a central opening with narrowing slots extending outward providing access for the waste items and tool holding such items to be positioned therein and moved outward within any of the slots allowing for a wiping action to remove the waste item from the tool and the waste item to remain within the hollow receptacle for later disposal.

In a further aspect of the present invention for the single ring-shaped structure molded to and below the hollow waste receptacle being sized to be adjustable for a single human finger, or for two adjacent fingers, with the adjustability being to adjust outwardly to retain a certain amount of snugness to the one or more fingers. One additional aspect of the present invention is for the single ring-shaped hand mounting structure to have outwardly extending opposing arms or wings that overlie adjacent fingers to create stability and prevent the waste receptacle from moving rotationally in either a rightward or leftward direction away from its upright position atop the single finger.

The present invention seeks to provide an ergonomic solution to the problem of the existing limitations of desk/work area clutter by providing a secure hand mounted waste item receptacle reducing desk/work area clutter and providing the worker with a secure place to store the waste items as the documents are being created. This invention solves this problem by providing a simple hands-free effective way to quickly remove sticky vinyl from the workspace, and then from the end of the crafting hook, while securely storing the waste item in a convenient location for later disposal by the user. The present invention is comprised of a hollow receptacle, that can be of any geometric shape conducive to having a molded base conjoined to a single ring-shaped structure beneath for mounting to a human finger or fingers. The hollow receptacle will have a central opening on its top surface opposite the molded base for connecting to one or more outwardly extending narrowing slots. The crafting hook with a piece of vinyl scrap stuck to its end will be able to be placed through the opening and into the hollow body of the receptacle. The scrap of vinyl or other object will be caught within the hollow body and scraped off the crafting hook by the flaps on opposing sides of the slot as the crafting hook travels outwardly along any desired narrowing slot of the receptacle. The hollow body of the receptacle will be molded to a single ring-shaped structure for securing to the finger or fingers of one hand of a user. In this manner the waste receptacle will be removed from the desk or other workspace, keep both hands of the user free while in use and ensure that the secured waste item containment receptacle will remain stationary and substantially upright so that all of the waste items placed within the receptacle remain therein.

The invention may be described as a hand mounted waste receptacle comprising a body, the body defining wall, the wall enclosing a hollow internal volume, the wall also defining a top central opening communicating through the wall to the hollow internal volume, the central opening providing exclusive communication through the wall to the hollow internal volume. The invention also includes a plurality of leaves defined by the wall in cooperation with the central opening, the leaves being radially disposed about the central opening with each leaf being immediately adjacent to another leaf, each two immediately adjacent leaves defining an acute angle therebetween with each acute angle oriented and opening toward the central opening. Also included as part of the description is that the body further defines a hand mount in the form of a single ring-shaped opening for accommodating and mounting to a user's hand by inserting one or more fingers through a single ring-shaped opening. The hand mounted waste receptacle further describes the wall as also defining a plurality of slots with each of the slots having a slot length greater than its respective slot width and with each slot being arrayed radially about the central opening and providing an exclusive communication through the wall to the hollow internal volume. The single ring-shaped hand mount and the body of the hand mounted waste receptacle define a unitary structure.

The single ring-shaped hand mount of the hand mounted waste receptacle defines a single ring-shaped opening which is sized to accommodate a single finger of the user having an expansion slot midway around the ring-shaped opening opposite the bottom of the body which is positioned opposite to the central opening. The hand mounted waste receptacle further comprises an opposing pair of outwardly extending arms disposed on either side of the single ring-shaped opening for accommodating adjoining fingers of the user for providing stops against rotational motion about the single finger positioned within the single ring-shaped opening. The opposing pair of outwardly extending arms extend a like distance as the single ring-shaped opening from the bottom of the body being concavely curved to accommodate the adjoining fingers of the user. The paired outwardly extending arms of the single ring-shaped opening for accommodating one finger of the user prevents accidental rotation of the hand mounted waste receptacle when mounted onto the single finger of the user by the adjoining fingers of the user positioned within the concavely curved extension arms.

A further embodiment of the invention resides in the single ring-shaped hand mount defining a single ring-shaped opening which is sized to accommodate two adjoining fingers of the user having an expansion joint midway around the ring-shaped opening opposite the bottom of the body which is positioned opposite to the central opening. The single ring-shaped opening for accommodating two adjoining fingers of the user prevents accidental rotation of the hand mounted waste receptacle when mounted onto the two adjoining fingers of the user. The expansion joint of the single ring-shaped opening for accommodating two adjacent fingers will tend to straighten and flatten to accommodate larger adjoining fingers of the user.

The foregoing has outlined rather broadly the features and technical advantages of the present invention in order that the detailed description of the invention that follows may be better understood. Additional features and advantages of the invention will be described hereinafter that will form the subject of the claims for the invention. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organizational structure and method of operation, together with further objects and advantages, will be better understood from the following description when considered in connection with the several accompanying drawing figures. It is to be expressly understood, however, that each of the drawing figures is provided for the purpose of illustration and display only of the elements of the invention and is not intended as a definition of the limits of the present invention.

### BRIEF DESCRIPTION OF THE DRAWINGS

For the purpose of illustrating the invention, there is shown in the drawings forms which are presently preferred; it being understood, however, that the invention is not limited to the precise arrangements and instrumentalities shown.

FIG. 1 illustrates a first embodiment of the present invention with accompanying tool set.

FIG. 2 is an enlargement of the first embodiment of the present invention of FIG. 1 tilted slightly forward to show the elements along the top surface.

FIG. 3 is a front view of the first embodiment of the present invention.

FIG. 4 is a perspective view of the bottom surface of the first embodiment of the present invention showing the expandable single ring portion capable of engaging with a single finger of a user.

FIG. 5 is a front view of a second embodiment of the present invention showing an enlarged single ring portion capable of engaging with two fingers of a user.

### DETAILED DESCRIPTION OF THE PREFERRED EMBODIMENTS

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include the plural referents unless the context clearly dictates otherwise. Thus, for example, reference is made to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

It further will be understood that the terms “comprises,” “comprising,” “includes,” and “including” specify the presence of stated features, steps, or components. It also should be understood and noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means the dimensions, sizes, formulations, parameters, shapes, and other quantities and characteristics are not and need not be exact, but may be approximated and/or larger or smaller, as desired, reflecting tolerance, conversion factors, rounding off, measurement error and the like and other factors known to those of skill. Further, unless otherwise stated, the term “about” shall expressly include “exactly.”

The term “user” and “worker” refers to an entity, e.g., a human, that utilizes a device according to the present invention in order to bring about a desired effect or outcome. In a particular case, the user is one who places material into the receptacle. For such a user, the terms “user” and “worker” may be used interchangeably.

The term “invention” or “present Invention” refers to the invention being applied for via the present patent application with the title “Single-Ring Hand Mounted Secure Item Waste Receptacle.” The term “invention” may be used interchangeably with ‘waste receptacle.’

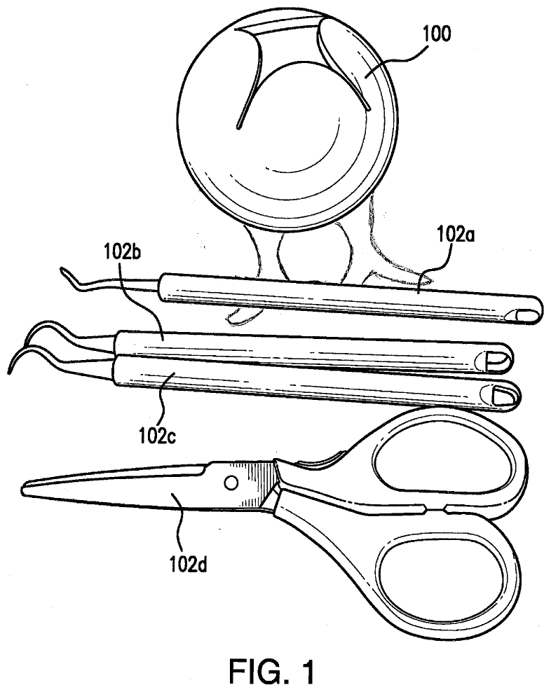

The following description relates to an article of manufacture for providing a hand mounted secure waste receptacle capable of mounting to one or more fingers of a user according to the present invention. To better understand the invention and referring now to the drawings in detail, there is shown in FIG. 1 a first embodiment of the article of manufacture for providing a secure item waste receptacle for mounting to a finger of a user's hand. A secure item waste receptacle 100 is shown with a set of tools 102a-d that are useful when a graphic artist works with physical renditions of items that require layers of textured material rather than working with digital representations of these objects. These tools 102a-d permit the worker to add, cut, and remove layers of textured material from the documents or similar object being created. These tools 102a-d may include various picks and cutting tools, including scissors 102d for working with layers of textured material.

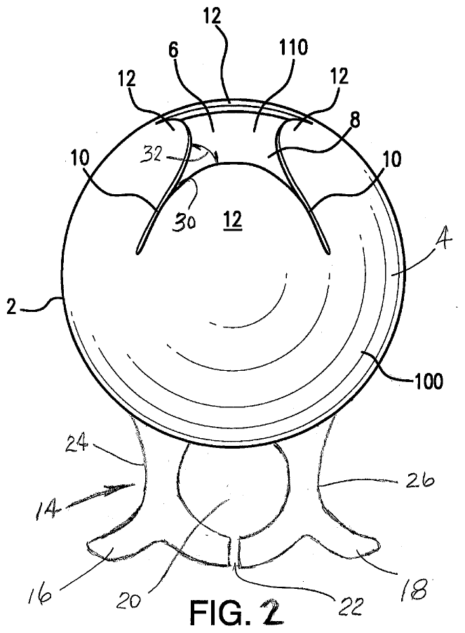

The hand mounted secure item waste receptacle 100 provides a storage location for the textured items that are waste from the creation of the object. Additional details regarding the hand mounted secure item waste receptacle 100 are described below in reference to FIGS. 2-5.

FIG. 2 shows the hand mounted secure item waste receptacle 100, a body 2, a wall 4 and an inside volume 6. The opening 110 includes a central opening 8 and a plurality of slots 10 disposed about the central opening 8. The opening 110 provides exclusive communication through wall 4 to the inside volume 6. The body 2 and single ring-shaped hand mount 14 define a unitary structure. The wall 4 disposed between the central opening 8 and the slots 10 defines a plurality of leaves 12. The leaves 12 are disposed about the central opening 8 and each of the leaves 12 is adjacent to another leaf 12. Each pair of adjacent leaves 12 defines an acute angle 32 therebetween. Each acute angle 32 is defined by a vertex 30. The acute angle 32 is oriented to open toward the central opening 8.

The hand mounted secure item waste receptacle 100 is mountable to at least one finger of the user by means of the single ring-shaped hand mount 14. The hand mount 14 is comprised of two molded extensions 16, 18 extending from the bottom surface of the secure item waste receptacle 100. Each of the extensions 16, 18 are the mirror images of the other. The two inward facing surfaces of the extensions 16, 18 have a concave curvature to form the ring-shaped opening 20. At the bottom of the ring-shaped opening 20 there is a slot 22 that affords for the expansion of the ring-shaped opening 20 to accommodate differently sized fingers of the user. Each of the two outward facing surfaces of the extensions 16, 18 also exhibit concave surfaces 24, 26 in order to fit more snugly against adjacent fingers of the user where the fingers of the users are adjacent to the finger placed within the ring-shaped opening 20 of the hand mounted secure item waste receptacle 100.

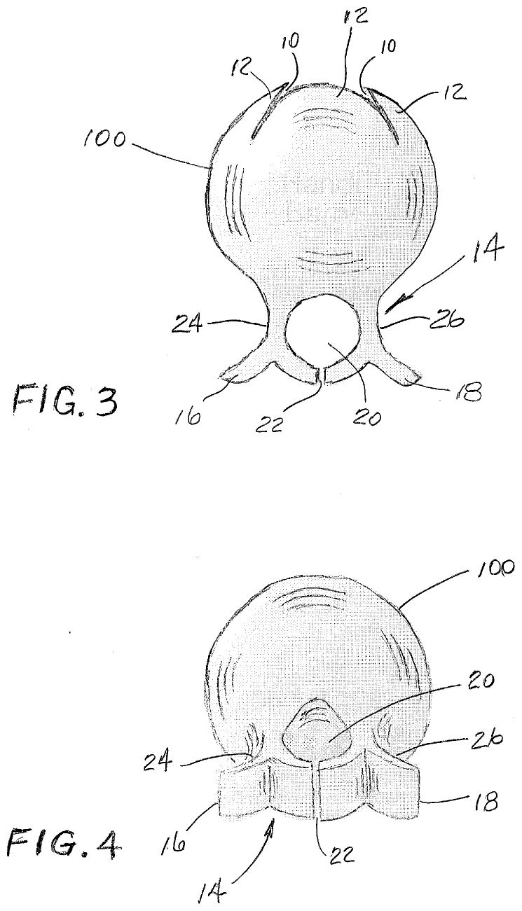

Referring now to FIG. 3 the hand mounted secure item waste receptacle 100 is shown in vertical orientation with the front face fully viewable. Three of the leaves 12 and slots 10 are shown across the top surface of the waste receptacle 100. The single ring-shaped hand mount 14 is shown attached to the bottom surface of the waste receptacle 100 as part of the integrated molded entirety of the waste receptacle 100. The central opening 20 of the single ring-shaped hand mount 14 is expandable by enlargement of the slot 22 located at the bottom of the opposing extensions 16, 18 under the opening 20 to accommodate differently sized user fingers. As an example, if the user places the hand mounted waste receptacle 100 on the first or third (ring) finger there is little likelihood of the slot 22 expanding very much, or at all. If the user places the waste receptacle 100 on the middle finger, which is normally the largest finger in girth, the slot 22 will expand to accommodate the larger finger. Each of the extensions 16, 18, that form the single ring-shaped structure between them, form a concave curve 24, 26, respectively, so as to accommodate the adjacent fingers of the user on either side of the finger upon which the waste receptacle 100 is mounted in order that the waste receptacle 100 is stabilized from manual or gravitational rotation while in use.

FIG. 4 shows the same embodiment as in FIG. 3 but titled backward away from the vertical to show the bottom arrangement of elements, particularly the single ring-shaped hand mount 14 of the waste receptacle 100. The slot 22 is clearly shown as a continual opening between the two extensions 16, 18, as well as the continuing curvature of the adjacent finger gripping curvatures 24, 26 on both sides of the opening 20 along both lateral sides of the exterior of the expandable single ring-shaped hand mount 14. In accordance with this structure, the hand mounted secure item waste receptacle 100 can be worn on one or more different user fingers and be stabilized from rotational action by the inwardly curved extensions 24, 26 surrounding the central bottom finger opening 20 by the inward gripping of adjacent fingers of the user for securely depositing waste within the waste receptacle 100 without need for the waste receptacle 100 to take up space on a desk or workspace.

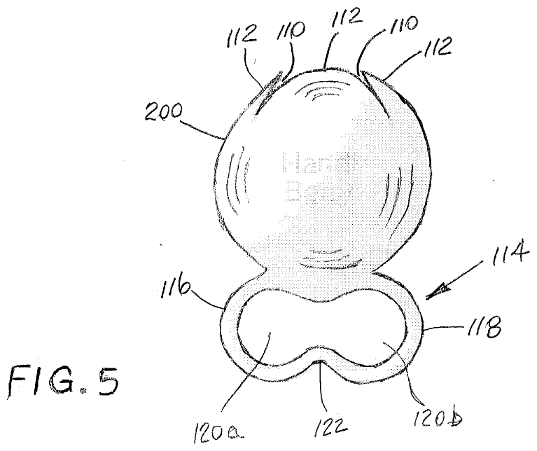

Referring now to FIG. 5, there is shown a second embodiment of the hand mounted secure item waste receptacle 200 in a vertical orientation showing the front face of the waste receptacle. The waste receptacle 200 is, in all respects, dimensionally the same as the waste receptacle 100 described above in greater detail. The sole exception being the expandable single ring-shaped hand mount 114 that can accommodate two fingers of the user within the ring. In the case of the single ring-shaped hand mount 114, each of the extensions 116, 118 meet at the bottom of the ring at an inwardly curved expansion joint 122 forming right and left finger openings 120a, 120b. When larger fingers are inserted into the single ring-shaped hand mount 114, the expansion joint 122 flattens from its relaxed inwardly curved position to accommodate the larger fingers of the user. With two fingers inserted into the single ring-shaped hand mount 114 stability from rotational movement is achieved without any inward force from external support against the single ring-shaped mount. The stability comes from the adjacent fingers within the ring-shaped hand mount 114 preventing the waste receptacle 200 from rotating about the finger mount. This alternative stability mechanism is but another method to afford stability against rotation of the opening 8 into a downward orientation to potentially discharge the waste items from the waste receptacle 200, as are the outrigger finger supports 24, 26 of the waste receptacle 100.

Thus, in accordance with the teachings of either of the embodiments of the present invention, the waste receptacle 100, 200 is removed from the surface of the desk or workspace and placed on the hand of a user by mounting the waste receptacle 100, 200 to one or more fingers of the user. In this way the waste receptacle 100, 200 travels with the hand of the user and is always immediately available for the depositing of waste items therein. Whether the single finger (with adjacent opposing finger positions) single ring-shaped mount 14 or the paired two finger single ring-shaped mount 114 is used with the invention rotational movement is curtailed by the use of the concave adjacent finger inwardly curved gripping extensions 24, 26 or by the paired side-by-side fingers of the user placed within the single ring-shaped mount 114. The invention is expandable to accommodate differently sized fingers by either the expansion slot 22 or by the flattening of the inwardly curved expansion joint 122 located along the bottom of the ring-shaped mount 14, 114, respectively.

It will be further understood that various changes in the details, materials, and arrangements of the parts which have been described and illustrated in order to explain the embodiments of this invention may be made by those skilled in the art without departing from the embodiments of the invention encompassed by the following claims.

The present invention may be embodied in other specific forms without departing from the spirit or essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A hand mounted waste receptacle comprising
a body, the body defining wall, the wall enclosing a hollow internal volume, the wall also defining a top central opening communicating through the wall to the hollow internal volume, the central opening providing exclusive communication through the wall to the hollow internal volume;
a plurality of leaves defined by the wall in cooperation with the central opening, the leaves being radially disposed about the central opening with each leaf being immediately adjacent to another leaf, each two immediately adjacent leaves defining an acute angle therebetween with each acute angle oriented and opening toward the central opening;
the body further defining a hand mount in the form of a single ring-shaped opening for accommodating and mounting to a user's hand by inserting one or more fingers through a single ring-shaped opening.

2. The hand mounted waste receptacle of claim 1, the waste receptacle further comprising:
The wall defining a plurality of slots wherein each of the slots has a slot length greater than its respective slot width with each slot being arrayed radially about the central opening and providing an exclusive communication through the wall to the hollow internal volume.

3. The hand mounted waste receptacle of claim 1 wherein the single ring-shaped hand mount and the body define a unitary structure.

4. The hand mounted waste receptacle of claim 1 wherein the single ring-shaped hand mount defines a single ring-shaped opening which is sized to accommodate a single finger of the user having an expansion slot midway around the ring-shaped opening opposite the bottom of the body which expansion slot is positioned opposite to the central opening.

5. The hand mounted waste receptacle of claim 4 further comprising an opposing pair of outwardly extending arms disposed on either side of the single ring-shaped opening for accommodating adjoining fingers of the user for providing stops against rotational motion about the single finger positioned within the single ring-shaped opening.

6. The hand mounted waste receptacle of claim 5 further comprising the opposing pair of outwardly extending arms extending a like distance as the single ring-shaped opening from the bottom of the body and being concavely curved to accommodate the adjoining fingers of the user.

7. The hand mounted waste receptacle of claim 6 wherein the paired outwardly extending arms of the single ring-shaped opening for accommodating one finger of the user prevents accidental rotation of the hand mounted waste receptacle when mounted onto the single finger of the user by the adjoining fingers of the user positioned within the concavely curved extension arms.

8. The hand mounted waste receptacle of claim 1 wherein the single ring-shaped hand mount defines a single ring-shaped opening which is sized to accommodate two adjoining fingers of the user having an expansion joint midway around the ring-shaped opening opposite the bottom of the body which is positioned opposite to the central opening.

9. The hand mounted waste receptacle of claim 8 wherein the single ring-shaped opening for accommodating two adjoining fingers of the user prevents accidental rotation of the hand mounted waste receptacle when mounted onto the two adjoining fingers of the user.

10. The hand mounted waste receptacle of claim 9 wherein the expansion joint will tend to straighten and flatten to accommodate larger adjoining fingers of the user.
